(19) United States
(12) Patent Application Publication
(10) Pub. No.: US 2014/0096533 A1
(43) Pub. Date: Apr. 10, 2014

(54) Bearing chamber venting system for an aircraft engine and method for providing a required pressure ratio at bearing chamber seals of an air-sealed bearing chamber

(71) Applicant: Rolls-Royce Deutschland Ltd & Co KG, Blankenfelde-Mahlow (DE)

(72) Inventors: Christian HOMEYER, Berlin (DE); Thomas SCHILLINGER, Berlin (DE)

(73) Assignee: Rolls-Royce Deutschland Ltd & Co KG, Blankenfelde-Mahlow (DE)

(21) Appl. No.: 14/043,507

(22) Filed: Oct. 1, 2013

(30) Foreign Application Priority Data
Oct. 4, 2012 (DE) 10 2012 218 135.0

(51) Int. Cl. F01D 25/18; F02C 7/28

(52) U.S. Cl. CPC F01D 25/183; F02C 7/28
USPC 60/778; 416/174; 60/39.08; 60/787; 60/772

(57) ABSTRACT

A bearing chamber venting system for an aircraft engine includes at least one bearing chamber air-sealed by sealing air via bearing chamber seals, a vent line connected to the bearing chamber, via which an oil/air mixture present in the bearing chamber is vented out, and an oil separator connected to the vent line. An oil return line is connected to the oil separator via which oil separated from the mixture is discharged. An air outlet line is connected to the oil separator, via which cleaned air is passed to the environment. An air ejector is arranged in the air outlet line to eject gas supplied to the air ejector into the air outlet line at a speed which is greater than the speed of the air flowing in the air outlet line and passed to the environment out of the oil separator.

### CROSS-REFERENCE TO RELATED APPLICATION

This application claims the benefit of German Patent Application No. 10 2012 218 135.0 filed on Oct. 4, 2012 and is fully incorporated herein by reference.

### BACKGROUND

This invention relates to a bearing chamber venting system for an aircraft engine and a method for providing a required pressure ratio at bearing chamber seals of an air-sealed bearing chamber of an aircraft engine.

An aircraft engine substantially includes a compressor, a combustion chamber and a turbine. The compressor and the turbine are connected to one another via a shaft. This shaft is mounted in a so-called bearing chamber with bearing elements that are lubricated and cooled with oil. The oil is here usually drawn from an oil tank, supplied by means of an oil conveying pump via a line system and one or more oil filters to the bearing chamber and to the bearing elements, and returned to the oil tank via an oil sump inside the bearing chamber and further lines and an oil suction pump, so that an oil circuit is obtained.

To prevent any leakage of oil out of the bearing chambers, the latter are provided with seals and additionally subjected to so-called sealing air from the outside. This sealing air forms an excess pressure (so-called sealing pressure) around the bearing chambers and the seals, so that a positive pressure ratio is achieved at the bearing chamber seals. This means that the air pressure outside the bearing chamber, i.e. the sealing pressure, is greater than the air pressure inside the bearing chamber (so-called chamber pressure). With this positive pressure ratio, air flows into the bearing chamber via the seals and thus prevents oil leaking from the latter. This sealing air is usually drawn from the compressor of the turbomachine (as so-called bleed air) and supplied to the bearing chamber from the outside.

Since the oil suction pump which extracts the oil collected in the oil sump cannot as a rule cope with the additional air supply to the bearing chamber, the bearing chamber is vented for that reason. The venting system provided for this purpose usually consists of one or more vent lines which extend from the interior of the bearing chamber. These vent lines lead to an oil separator (also referred to as breather). In this oil separator, the oil is separated from the air, with the separated oil being returned by a suction pump to the oil tank so that it remains in the oil circuit. The air cleaned of oil is discharged from the oil separator to the environment of the engine via an air outlet line.

A venting system of this type is usually designed such that it operates using its natural pressure gradient. This means that the highest pressure is the sealing pressure prevailing around the bearing chamber, and this pressure is then relieved at the bearing chamber seals, the bearing chamber proper, the one or more vent lines and the oil separator plus the air outlet line, to the ambient air outside the engine.

The previously described bearing chamber venting system is disadvantageous in that under certain conditions, the sealing air supply to the seals of the bearing chamber can be too low, such that the sealing pressure is insufficient to obtain a positive pressure ratio at the bearing chamber seals. This can result in oil leaking from the bearing chamber, in which event there is a possibility of oil getting into the gas path of the compressor and from there into the bleed line for supplying fresh air to the aircraft, which must of course be prevented.

Too low a sealing pressure at the seals of the bearing chamber may result from the fact that the compressor pressure built up by the compressor is not sufficient for supplying enough air to the bearing chamber. Reasons for this can be transient processes, such as engine starting or so-called engine cranking, by which is understood cranking of an engine using an engine starter without starting the engine, and other transient processes of the engine such as rapid load cycles of the compressor. Because the compressor capacity is not yet available, in cases such as this the sealing air supply can be too low, so that the sealing pressure is lower than the chamber pressure and a negative pressure ratio prevails, resulting in oil leaking from the bearing chamber.

### SUMMARY

An object underlying the present invention is accordingly to provide a bearing chamber venting system for an aircraft engine which assures, even in the event of a low sealing air supply to the seals of the bearing chamber, a positive pressure ratio at the bearing chamber seals. Furthermore, a method is to be provided for assuring a positive pressure ratio at the bearing chamber seals of an air-sealed bearing chamber of an aircraft engine.

It is provided in accordance with an exemplary embodiment of the invention that an air ejector is arranged in the air outlet line, via which the cleaned air is passed from the oil separator into the engine environment. The air ejector is designed here to eject a gas supplied to the air ejector from an external source into the air outlet line at a speed which exceeds the speed of the air discharged from the oil separator. In this way, the air ejector ensures an air flow acceleration which generates a pressure drop in the bearing chamber venting system, which in turn leads to a positive pressure ratio at the bearing chamber seals being attained despite a reduced sealing pressure at the bearing chamber seals. In transient processes too, such as engine starting or engine cranking, and in other transient processes of the engine such as rapid load cycles of the compressor, a positive pressure ratio at the bearing chamber seals is thus obtained.

The solution in accordance with the invention is accordingly based on the concept of arranging an air ejector in the air duct or the air line between the oil separator and the engine environment, said injector generating by its activation a pressure drop in the bearing chamber venting system in the event of an insufficient sealing air supply, and hence ensuring a positive pressure ratio at the bearing chamber seats, so that contamination of the gas path of the compressor and of the bleed air for supplying fresh air to the aircraft is dependably prevented.

In accordance with an exemplary embodiment of the present invention, it is provided that the air ejector is arranged in the air outlet line such that the flow direction of the gas discharged by the air ejector is substantially identical to the flow direction of the cleaned air flowing through the air outlet line from the oil separator into the environment. To do so, it is for example provided that the air ejector has a pipe with a pipe opening arranged in the air outlet line such that said pipe opening points downstream. The air ejected by the air ejector has a higher speed here than the air flowing from the oil separator into the environment without air ejector, so that this air is accelerated by the ejected air, thereby creating a negative pressure. The physical effect used here is the same as that used in a Venturi nozzle.

It can furthermore be provided that the pipe of the air ejector is equipped with a nozzle in order to provide the highest possible speed of the gas discharged by the air ejector.

The exact position of the air ejector in the air outlet line between the oil separator and the environment is not crucial here, since the physical effect occurring does not depend on the position of the air ejector. The precise shape and design of the air outlet line between oil separator and environment is also not crucial for the present invention, provided that a sufficient negative pressure can be generated in the air outlet line by the air ejector.

In accordance with an exemplary embodiment of the invention, the air ejector is connected such that it is activated automatically when a compressed air-operated starter of the aircraft engine is subjected to compressed air. This compressed air is as a rule provided by an aircraft air system which is usually fed with compressed air by an auxiliary engine or by an aircraft engine already in operation, or also by an external compressed air supply connected for that purpose to the aircraft air system. In accordance with a first embodiment, the air ejector once activated is subjected to part of the compressed air made available to the starter by the aircraft air system. The air ejector is thus incorporated such that part of the compressed air is drawn from the compressed air supply to the starter and supplied to the air ejector.

In accordance with a second exemplary embodiment, the air ejector once activated is subjected to part or all of the waste air of the starter. The air ejector is thus incorporated in such a way that part or even all of the air quantity is drawn from the air discharged by the starter and made available to the starter.

It is however pointed out that the two sources mentioned for supplying air to the air ejector should only be understood as examples. The air supply to the air ejector can in principle be provided by any compressed air or gas sources. It can, for example, also be provided alternatively that the air ejector receives compressed air directly from the aircraft air system or from an auxiliary engine of the aircraft.

In accordance with a further exemplary embodiment of the present invention, the system in accordance with the invention includes a control system which controls the operation of the air ejector, for example by the use of control valves in the compressed air supply line to the air ejector, such that the latter is only operated and generates a negative pressure in the air outlet line of the oil separator when the pressure ratio of sealing pressure to chamber pressure at the bearing chamber seals of the air-sealed bearing chamber is below or drops below a predetermined value or is below a predetermined value. Corresponding control of the air ejector can for example be achieved by sensors arranged inside and outside the bearing chamber. Control of this type can however also be achieved in a simplified manner by detecting certain operating parameters, for example by detecting whether engine starting or engine cranking, as well as other transient processes of the engine such as rapid load cycles of the compressor, are in progress or whether the compressor of the engine is supplying sealing air to a sufficient extent.

It is pointed out that one or more vent lines can be provided between the bearing chamber and the oil separator. Furthermore, several bearing chambers or other engine components which must be supplied with oil and vented, such as a gearbox for example, can be connected to the oil separator via vent lines. The vent lines and their connection to the bearing chamber and the oil separator can in principle be of any type, provided a pressure drop in the venting system is assured and is propagated into the bearing chamber via the at least one vent line.

The present invention relates in a further exemplary aspect to a method for providing a required pressure ratio at bearing chamber seals of an air-sealed bearing chamber of an aircraft engine. A sealing pressure generated by sealing air is here applied to the bearing chamber seals on the outside and a chamber pressure is applied on the inside. An oil/air mixture present in the bearing chamber is supplied to an oil separator via at least one vent line. After separation of the oil out of the oil/air mixture, cleaned air is discharged from the oil separator to the environment via an air outlet line. It is provided in accordance with the invention that if a required ratio of sealing pressure to chamber pressure at the bearing chamber seals is not achieved or not present at the air outlet of the oil separator, a negative pressure is generated which is propagated at least partially into the bearing chamber via the oil separator and the at least one vent line. In this case, the chamber pressure of the bearing chamber drops, which leads to the required ratio between sealing pressure and chamber pressure at the bearing chamber seals being provided even if the sealing pressure is comparatively low.

### BRIEF DESCRIPTION OF THE DRAWINGS

The present invention is described in the following in more detail with reference to the figures of the accompanying drawing, showing an exemplary embodiment.

FIG. 1 shows an exemplary embodiment of a bearing chamber sealed by sealing air and to which a vent line is connected.

FIG. 2 shows an exemplary embodiment of an oil separator which on the inlet side has several vent lines starting from a bearing chamber in accordance with FIG. 1 and on the outlet side includes an oil return line and an air outlet line, with an air ejector being integrated into the air outlet line.

FIG. 3 shows an exemplary embodiment of a starter for starting an aircraft engine, which provides compressed air for an air ejector in accordance with FIG. 2.

### DETAILED DESCRIPTION

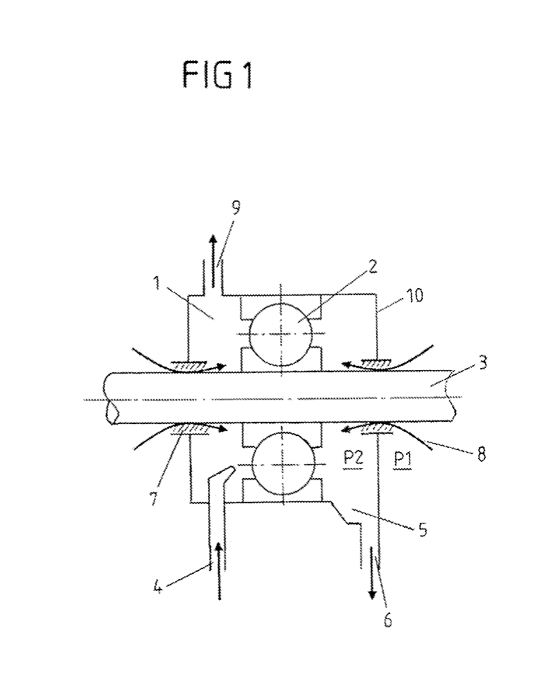

FIG. 1 shows a bearing chamber 1 surrounded by a bearing casing 10. One or more bearing elements 2 are located inside the bearing chamber 1 and are used for mounting a mechanical part of an aircraft engine, in this case a rotating engine shaft 3. The bearing element 2 is lubricated and cooled with oil supplied via an oil inlet 4 of the bearing chamber 1. The oil collects in a bearing chamber oil sump 5 inside the bearing chamber 1 and leaves the latter via an oil outlet 6.

The bearing chamber 1 and the bearing casing 10, respectively, are sealed in the area of the rotating shaft 3 using seals 7. These bearing chamber seals 7 are additionally subjected to sealing air 8. The sealing air 8 presses on the seals 7 and thereby prevents any leakage of oil. The sealing air 8 provides a so-called sealing pressure P1 at the outside of the bearing casing 10. A chamber pressure P2 prevails inside the bearing chamber 1. To ensure that the sealing air 8 dependably prevents any leakage of oil out of the bearing chamber 1 in conjunction with the seals 7, a positive pressure ratio P1/P2 must prevail, i.e. the sealing pressure P1 must be greater than the chamber pressure P2.

The bearing chamber seals 7 are for example labyrinth seals, carbon seals or brush seals. The sealing air 8 is tapped in normal operation from the engine compressor and supplied via pipes, ducts etc. to the bearing chamber seals 7 and hence to the bearing chamber 1.

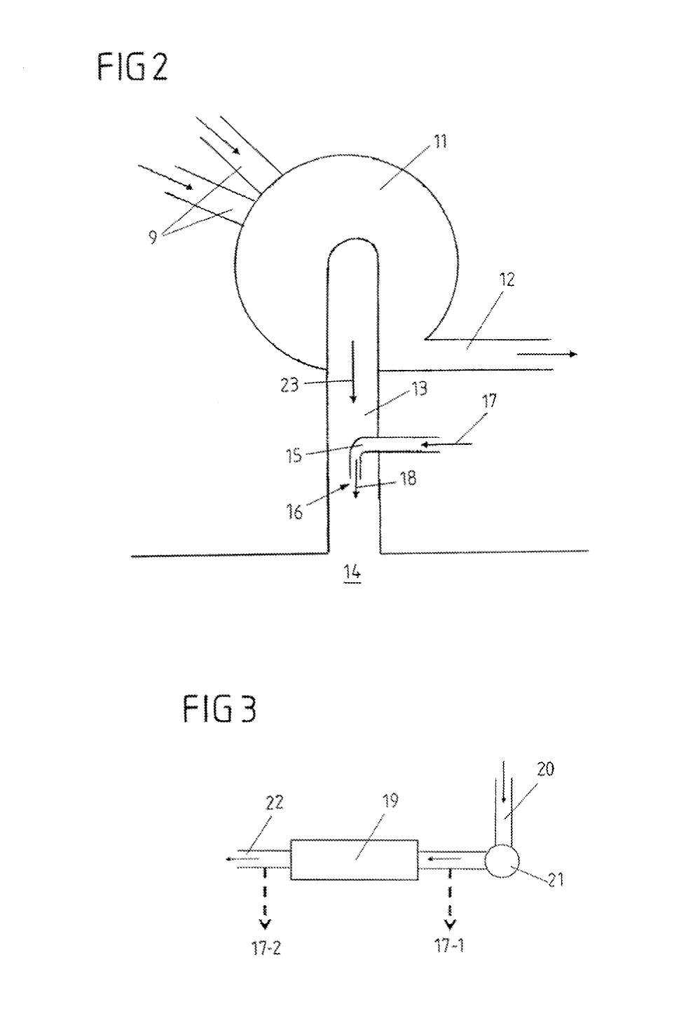

Due to the positive pressure ratio P1/P2, the sealing air 8 enters to a minor extent, via the bearing chamber seals 7, the bearing chamber 1 in which an oil/air mixture prevails, so that venting is necessary. The oil/air mixture is vented via a vent line 9 connected to the bearing chamber 1. This oil/air mixture is in the further process supplied to an oil separator shown in FIG. 2.

The oil separator 11 shown in FIG. 2 includes one or more inlets 9 formed by the ends of vent lines 9 corresponding to the vent line 9 of FIG. 1. It can be provided here that a bearing chamber 1 is connected to the oil separator 11 via one or more vent lines 9. it can also be provided that vent lines 9 lead to the oil separator 11 from a plurality of bearing chambers and/or other engine components, such as a gearbox. The oil/air mixture of the bearing chamber 1 is supplied to the of separator 11 via the vent lines 9.

Inside the oil separator, the oil/air mixture is separated in a manner known per se into its oil and air constituents, for example by centrifugal effect. The oil constituents are supplied via a return line 12 to an oil tank, so that they remain in the oil circuit. The cleaned air 23 is passed via an air outlet line 13 to the engine environment 14.

It is now provided that an air ejector 15 is arranged in the air outlet line 13 between the oil separator 11 and the engine environment 14. The air ejector 15 is designed to eject a gas 17 supplied to the latter from another source into the air outlet line 13 at a speed which is greater than the speed of the flow of cleaned air 23 due to the pressure gradient between the oil separator 11 and the engine environment 14.

The gas 18 ejected by the air ejector 15 at high speed pulls along the cleaned air 23 flowing in the air outlet line 13, with a negative pressure being generated in the air outlet line 13 which is propagated into the oil separator 11 and from the latter into the bearing chamber 1 via the vent lines 9. The physical principle applying here is that of the Venturi nozzle.

The air ejector 15 is designed as a pipe, the opening 16 of which is pointing downstream, so that the effect described is achieved effectively. It can be additionally provided here that the pipe 15 has a taper at or close to the pipe opening for providing a nozzle function.

The source of the gas 17 supplied to the air ejector 15 can in principle be of any type. The supplied gas is in particular compressed air. An exemplary embodiment in this connection is described in the following on the basis of FIG. 3.

FIG. 3 shows a so-called starter 19, which rotates the compressor shaft of an aircraft engine to start the latter. A starter 19 of this type is driven by compressed air 20, provided for example, by an air system of the aircraft, and activated by a starter valve 21. When the starter valve 21 is opened, compressed air passes to the starter 19.

In accordance with a first embodiment, it is provided that part of this supplied compressed air 20 is drawn from the area between the starter valve 21 and the starter 19 and supplied as compressed air 17 via an air supply 17-1 to the air ejector 15 in FIG. 2, so that the latter can be operated accordingly and can fulfil the described function.

In a second exemplary embodiment, part or all of the waste air 22 of the starter 19 is supplied to the air ejector 15. The starter 19 is, when the starter valve 21 is opened, supplied with compressed air from an aircraft air system, and uses said compressed air 20 provided for starting an aircraft engine to drive its compressor shaft. In accordance with this exemplary embodiment, at least part of the waste air 22 is tapped and supplied as compressed air 17 via an air supply 17-2 to the air ejector 15 in FIG. 2.

The air ejector 15 in accordance with FIG. 2 is not operated permanently, but only under certain conditions, such as when the pressure ratio P1/P2 at the bearing chamber seals 7 in FIG. 1 is negative or threatens to become negative, i.e. when the chamber pressure P2 is greater than the sealing pressure P1 and hence there is a risk of oil leaking out of the bearing chamber 1 and reaching the gas path of the turbomachine. In this case, the air ejector 15 is activated. Due to the negative pressure generated, which is propagated from the oil separator 11 via the vent lines 9 into the bearing chamber 1 where it effects a pressure drop, a positive pressure ratio P1/P2 can be maintained even when the sealing pressure P1 only attains comparatively low values. A positive pressure ratio at the bearing chamber seals is again obtained or maintained due to the pressure drop in the bearing chamber.

The air ejector 15 must be designed and positioned such that in stationary engine operation, when it is not activated, it does not interfere with the normal venting function of the air outlet line 13. On the other hand, it must be designed, positioned and supplied with compressed air such that in transient engine operation, e.g. during starting of the engine or during so-called engine cranking, by which is understood cranking of an engine using an engine starter without starting the engine, and during other transient processes of the engine such as rapid load cycles of the compressor, a pressure drop is achieved at the air outlet of the oil separator due to the air ejected at high speed and is propagated via the oil separator and the at least one vent line at least partially into the bearing chamber, hence providing or maintaining a positive pressure ratio at the bearing chamber seals 7.

The air ejector can be activated in various ways. For example, it can be provided that in certain engine conditions the air ejector is activated automatically, for example in the event that the starter valve 21 is opened and compressed air is accordingly supplied to the starter 19, or that gas or compressed air is supplied to the air ejector via an alternative air supply line switched by means of a valve. Alternatively or additionally, sensor systems for detecting the current pressure ratios P1, P2 can also be provided as well as a control or regulating system that provides or maintains a required pressure ratio by appropriate activation of the air ejector 15.

The present invention provides a simple solution to the problem of maintaining a positive pressure ratio at the bearing chamber seals even in transient engine operation, since the existing infrastructure does not have to be changed and only one further line with appropriate air supply has to be arranged in the air outlet line between the oil separator and the engine environment.

Furthermore, a change to the existing sealing air system by means of, for example, an increased sealing air supply to the bearing chamber system is not required, which has the advantage that the bleed air drawn from the compressor for the sealing air supply is not changed and hence the compressor capacity is not impaired.

The invention is not restricted in its design to the exemplary embodiments set forth above, which must be understood only as examples. The design and the size ratios of the bearing chamber, of the oil separator and of the air ejector in the figures must therefore be understood only as examples. In addition, other engine components which must be supplied with oil and vented, such as a gearbox, can be connected to the oil separator. It can also be alternatively provided that the air ejector has active means, for example an integrated fan, to eject gas supplied to the air ejector at high speed into the air outlet line.

1. A bearing chamber venting system for an aircraft engine comprising:
at least one bearing chamber air-sealed by means of sealing air via bearing chamber seals with bearing elements provided for mounting a mechanical part of an aircraft engine,
at least one vent line connected to the bearing chamber, via which an oil/air mixture present in the bearing chamber is vented out of the bearing chamber,
an oil separator, to which the vent line is leading, with the oil/air mixture of the bearing chamber being supplied to the oil separator,
an oil return line connected to the oil separator via which oil separated from the oil/air mixture is discharged, and
an air outlet line connected to the oil separator, via which cleaned air is passed to the environment,
wherein an air ejector is arranged in the air outlet line and designed to eject gas supplied to the air ejector into the air outlet line at a speed which is greater than the speed of the air flowing in the air outlet line and passed to the environment out of the oil separator.

2. The system in accordance with claim 1, wherein the air ejector is arranged in the air outlet line such that the flow direction of the gas discharged by the air ejector is substantially identical to the flow direction of the cleaned air flowing through the air outlet line from the oil separator into the environment.

3. The system in accordance with claim 1, wherein the air ejector has a pipe with a pipe opening arranged in the air outlet line, with the pipe opening pointing downstream.

4. The system in accordance with claim 3, wherein the pipe is provided with a nozzle at or near the pipe opening.

5. The system in accordance with claim 1, wherein the air ejector is subjectable to the supply air or the waste air of a starter of the aircraft engine.

6. The system in accordance with claim 5, wherein the air ejector is subjectable to part of the compressed air made available to a starter by an aircraft air system or by an external compressed air source.

7. The system in accordance with claim 5, wherein the air ejector is subjectable to part or all of the waste air of the starter.

8. The system in accordance with claim 5, wherein the air ejector can be activated automatically when a starter of an aircraft engine is subjected to compressed air.

9. The system in accordance with claim 1, further comprising control system which controls the operation of the air ejector such that the latter is only operated when the pressure ratio of sealing pressure to chamber pressure at the bearing chamber seals of the air-sealed bearing chamber drops below a predetermined ratio or is below a predetermined ratio.

10. A method for providing a required pressure ratio at bearing chamber seals of an air-sealed bearing chamber of an aircraft engine, where a sealing pressure generated by sealing air is applied to the bearing chamber seals on the outside and a chamber pressure is applied on the inside, and where an oil/air mixture present in the bearing chamber is supplied to an oil separator via at least one vent line and, after separation of oil out of the oil/air mixture, cleaned air is discharged from the oil separator via an air outlet line to the environment,
wherein if a required ratio of sealing pressure to chamber pressure at the bearing chamber seals is not achieved or not present at the oil separator, a negative pressure is generated which is propagated at least partially into the bearing chamber via the at least one vent line, with the chamber pressure of the bearing chamber dropping and the required pressure ratio being provided.

11. The method in accordance with claim 10, wherein the negative pressure is provided by an air ejector arranged in the air outlet line, said air ejector ejecting a gas supplied to the latter by another source into the air outlet line at a speed which exceeds the speed of the air flowing in the air outlet line and discharged from the oil separator into the environment.

12. The method in accordance with claim 11, wherein the air ejector is subjected to the supply air or the waste air of a starter of the aircraft engine.
